(19) United States
(12) Patent Application Publication
(10) Pub. No.: US 2023/0286584 A1
(43) Pub. Date: Sep. 14, 2023

(54) METHOD FOR OPERATING A MOTOR VEHICLE WITH A PARKING ASSISTANT

(71) Applicant: Ford Global Technologies, LLC, Dearborn, MI (US)

(72) Inventors: Ahmed Benmimoun, Aachen (DE); Markus Krekel, Wermelskirchen (DE); Nadja Wysietzki, Koeln (DE); Andrew Ochmanski, Royal Oak, MI (US); Cinderella Matuk, Cologne (DE); Lars Kuhnert, Koln (DE); Thomas Gerlitz, Aachen (DE); Erick Michael Lavoie, Van Buren Charter Township, MI (US)

(73) Assignee: Ford Global Technologies, LLC, Dearborn, MI (US)

(21) Appl. No.: 17/654,063

(22) Filed: Mar. 8, 2022

(51) Int. Cl. B62D 15/02

(52) U.S. Cl. CPC B62D 15/0285

(57) ABSTRACT

A method for operating a motor vehicle (2) with a parking assistant (4), which is operable in an in-vehicle operating mode (SM) and a remote parking operating mode (RM), with the steps: (S100) reading data (D) indicative of a parking situation of a detected parking space (6), (S200) evaluating the data (D) to determine an output signal (AS) indicative of the in-vehicle operating mode (SM) or the remote parking operating mode (RM), and (S300) outputting the output signal (AS).

### FIELD

The invention relates to a method for operating a motor vehicle with a parking assistant, which allows the driver to control an active parking maneuver within the vehicle (“in-vehicle operating mode”) or from outside the vehicle (“remote parking operating mode”) in-vehicle. Furthermore, the invention relates to a computer program product, a parking assistant, and a motor vehicle with such a parking assistant.

### BACKGROUND

Such a parking assistant assists a driver in the in-vehicle operating mode when parking by taking over the steering maneuvers required for parking. After activating the parking assistant by pressing a button or falling below a certain speed, environmental sensors of the motor vehicle measure, for example, transversely to the direction of travel while passing one or more parking spaces. If a parking space is large enough, this is indicated to the driver. The parking assistant then automatically brings about parking in the parking space by means of steering interventions and engine interventions if the parking assistant is designed for self-driving. If the parking assistant is only designed for self-steering, the driver has to set the vehicle in motion by selecting the gear and operating the accelerator pedal, while the parking assistant controls the vehicle into the parking space by means of steering interventions and engine interventions.

In addition, in the remote parking operating mode the parking assistant can allow a driver to be outside the vehicle during the active parking maneuver. The parking process can then be monitored or controlled by the driver by means of a handheld device, such as a smartphone.

With the parking assistant in the remote parking operating mode, self-parking functions, such as home-zone parking or valet parking, can be realized with automatic parking and unparking of a motor vehicle. The driver can leave the vehicle in a transfer zone and the motor vehicle then automatically drives to a predetermined parking space.

A parking assistant which can be operated in an in-vehicle operating mode and a remote parking operating mode is known from U.S. Pat. No. 10,137,888 B2.

Further parking assistants are known from GB 2 511 351 A, U.S. Pat. No. 9,886,031 B2, US 2017/0 369 078 A1, U.S. Pat. No. 9,522,675 B1 and JP 6 044 334 B2.

However, such parking assistants do not make a choice from the available operating modes or they do not give a driver or user an indication as to which of the operating modes is preferable in a current scenario.

There is therefore a need to identify ways of remedying this situation.

### SUMMARY

The object of the invention is achieved by a method for operating a motor vehicle with a parking assistant, which can be operated in an in-vehicle operating mode and a remote parking operating mode, with the steps:
Reading data indicative of a parking situation of a detected parking space,
Evaluating the data to determine an output signal which is indicative of the in-vehicle operating mode or the remote parking operating mode, and
Outputting the output signal.

In other words, the present parking situation is analyzed on the basis of available data and then a recommendation is made for the in-vehicle operating mode or the remote parking operating mode, after which the driver may or may not follow this recommendation. Alternatively, it may also be provided that the output signal causes an automatic selection of the operating mode without the intervention of the driver. In this way, a driver can be given advice as to which operating mode of the operating modes is preferable in a current scenario.

According to one embodiment, the data are indicative of parking situation geometry data of the parking space. The geometry data may be representative of a motor vehicle orientation in the parking space (longitudinal or transverse parking), an offset of the motor vehicle relative to a center line, a motor vehicle angle, a parking space width, and a distance of the motor vehicle from the parking space.

According to a further embodiment, the data are indicative of parking situation environmental data for an environment of the parking space. The environmental data can be obtained using environmental sensors-such as LIDAR, RADAR, ultrasonic sensors, or camera systems of the motor vehicle. The environmental data may be representative of an angle of parked motor vehicles which are limiting the parking space, of other objects or obstacles which are limiting the parking space, or of traffic signs which allow parking in a specific orientation, for example. In this way, the environment of the parking space can also be analyzed.

According to a further embodiment, the data are indicative of a parking situation which is representative of traffic situations in the vicinity of the parking space. The traffic situation can be characterized by road traffic on a busy road where the parking space is located, or by the traffic prevailing in a parking garage or a traffic-restricted zone. For example, a hazard can be counteracted for a driver who would be exposed in the remote parking operating mode if he were outside the vehicle. The traffic situation may also affect public safety and/or permitted parking times. In this way, traffic situations in the vicinity of the parking space can also be analyzed.

According to a further embodiment, the data are indicative of parking situation personal data of the driver and/or of passengers of the motor vehicle. It can be taken into account, for example, that drivers and/or passengers of the motor vehicle require a lot of space to leave the car parked in the parking space due to individual restrictions on their mobility, for example due to disabilities.

According to a further embodiment, the data are indicative of a parking situation representative of the ground in the parking space. For example, it can be taken into account that part of the parking space is covered by a puddle or that the ground of the parking space is asphalt or lawn, for example.

According to a further embodiment, the data are indicative of a parking situation representative of a number of parking movements of a parking maneuver and/or meteorological data and/or state data and/or measured values. A parking movement shall be understood to mean a step of the parking maneuver in which the motor vehicle is moved in one direction. In other words, if the parking maneuver provides for the vehicle to travel forwards, then backwards and then backwards again, the parking maneuver has three parking movements. Thus, the number of required parking movements in the in-vehicle operating mode and in the remote parking operating mode is determined. The operating mode with the lowest number of parking movements can be selected. In addition or alternatively, it may be provided to compare the specified number of parking movements with a predetermined threshold value and to make an operating mode available for selection only if the number of parking movements required is less than the threshold value. In this way, unnecessarily long parking maneuvers can be avoided. The meteorological data are indicative of rain, for example. State data indicative, for example, of an active windscreen wiper, may also indicate rainy weather. The measured values can be values for an outside temperature.

Further, the invention includes a computer program product (e.g., a controller, a memory, and/or a processor located in the vehicle or the cloud and configured to execute the various steps via software described herein), a parking assistant, and a motor vehicle with such a parking assistant.

### BRIEF DESCRIPTION OF THE DRAWINGS

The invention will now be explained on the basis of a drawing. In the figures:

FIG. 1 shows in a schematic representation a first scenario in which a motor vehicle with a parking assistant is to be parked in a parking space.

FIG. 2 shows in a schematic representation a second scenario in which a motor vehicle with a parking assistant is to be parked in a parking space.

FIG. 3 shows in a schematic representation a third scenario in which a motor vehicle with a parking assistant is to be parked in a parking space.

FIG. 4 shows in a schematic representation a fourth scenario in which a motor vehicle with a parking assistant is to be parked in a parking space.

FIG. 5 shows a procedure sequence in a schematic representation.

### DETAILED DESCRIPTION

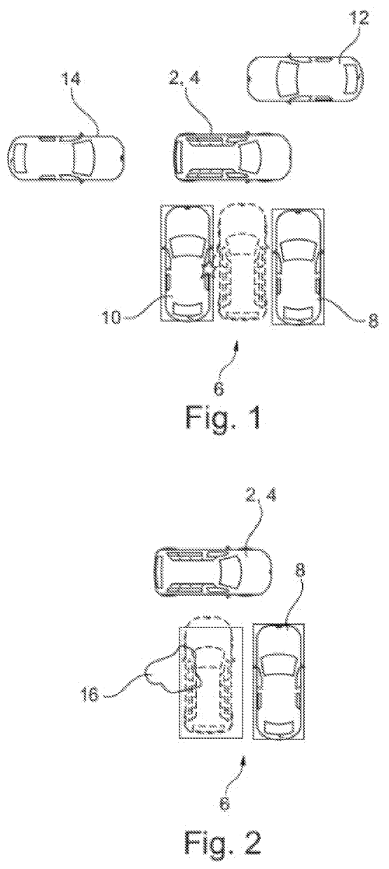

First of all, reference is made to FIGS. 1 to 4.

In the scenarios shown in FIGS. 1 to 4, a motor vehicle 2 is to be controlled into a parking space 6 by a parking assistant 4. For this purpose and for the tasks and functions described below, the parking assistant 4 can have hardware and/or software components.

The parking spaces 6 in the scenarios shown in FIGS. 1 to 4 are each designed for perpendicular parking. Deviating from the present exemplary embodiment, the parking spaces 6 may also be designed for parallel parking.

In the scenario shown in FIG. 1, a parking space 6 is limited by a right-hand motor vehicle 8 and a left-hand motor vehicle 10. The parking space 6 is located on a busy road, which is currently being used by motor vehicles 12, 14.

In the scenario shown in FIG. 2, the parking space 6 is limited only by a right-hand motor vehicle 8. There is a puddle 16 in the vicinity of the parking space 6.

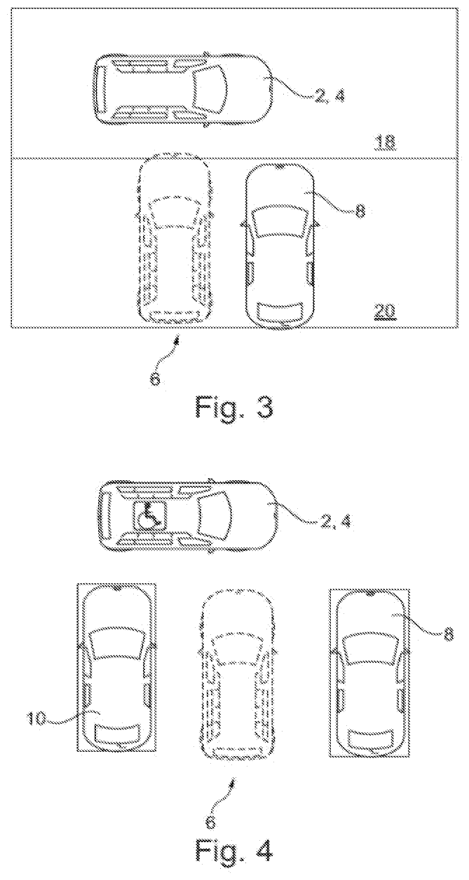

In the scenario shown in FIG. 3, the parking space 6 is also limited only by a right-hand motor vehicle 8. While the ground of the road is asphalt 18, the ground in the parking space 6 is lawn 20.

In the scenario shown in FIG. 4, the parking space 6 is limited by a right-hand motor vehicle 8 and a left-hand motor vehicle 10. The driver and/or passenger of the motor vehicle 2 have individual limitations on their mobility, for example due to disabilities. They therefore need a lot of space to be able to leave the motor vehicle 2 parked in the parking space 6.

The parking assistant 4 is designed to detect both the parking space 6 as well as the right-hand motor vehicle 8 and/or the left-hand motor vehicle 10 and/or the puddle 16 and/or the ground in the form of asphalt 18 or lawn 20 by evaluating environmental data provided by environmental sensors such as LIDAR, RADAR or ultrasonic sensors or camera systems.

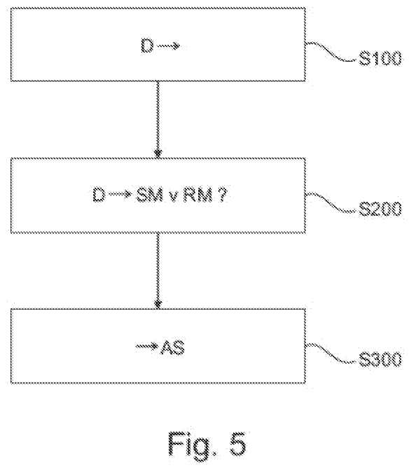

Furthermore, the parking assistant 4 may be designed to be operated in an in-vehicle operating mode SM (see FIG. 5) and a remote parking operating mode RM (see also FIG. 5).

During the in-vehicle operating mode SM, the driver remains seated in the motor vehicle 2 during parking into the parking space 6. On the other hand, during the remote parking operating mode RM, the driver gets out of the vehicle 2 beforehand and is then located outside the motor vehicle 2 during parking. In other words, the parking assistant 4 can be designed or operated as a self-steering system in the in-vehicle operating mode SM and as a remote parking assistant in the remote parking operating mode RM.

In order to give the driver or user an indication of which operating mode of the operating modes in-vehicle operating mode SM or remote parking operating mode RM is preferable in a current scenario, the parking assistant 4 is designed to read data D (see FIG. 5) indicative of a parking situation of the detected parking space 6, to evaluate the data D, to determine an output signal AS (see also FIG. 5) indicative of the in-vehicle operating mode SM or the remote parking operating mode RM and to output the output signal AS.

The output signal AS can then be output optically and/or acoustically and/or haptically, in order to inform the driver which of the operating modes is preferable in the present scenario.

In the present exemplary embodiment, the data D are indicative of parking situation geometry data of the parking space 6. The data D are representative, for example, of a motor vehicle orientation in the parking space (parallel or perpendicular parking), an offset of the motor vehicle relative to a center line of the parking space 6, a motor vehicle angle, a parking space width of the parking space 6, a distance of the motor vehicle 2 from the parking space 6 or a distance of the motor vehicle 2 from the parking space 6.

Thus, in FIG. 1 the parking space width of the parking space 6 is too small to open a driver's door of the motor vehicle 2 so far that the driver can easily get out, especially without damaging the motor vehicle 10.

Furthermore, in the present exemplary embodiment the data D are indicative of parking situation environmental data for an environment of the parking space 6. The data D are representative of an angle of motor vehicles 8, 10 which are limiting the parking space 6. In other words, it takes into account whether the vehicles 8, 10 are parked straight or skewed, thus reducing the space for parking maneuvers. Furthermore, in the present exemplary embodiment the data D are indicative of other objects or obstacles which are limiting the parking space 6, or of traffic signs, which for example only allow parking in a certain orientation (such as in a one-way street).

Furthermore, in the present exemplary embodiment the data D are indicative of a parking situation representative of traffic situations in the vicinity of the parking space 6. The data D therefore indicate that the environment of the parking space 6 is characterized by road traffic on a busy road, as shown in FIG. 1. By favoring the in-vehicle operating mode SM in this scenario, for example, a danger to the driver can be counteracted, since he now remains in the vehicle 2 and does not enter the traffic of the busy road, as would be the case if he were to use the remote parking operating mode RM, for example.

Furthermore, in the present exemplary embodiment the data D are indicative of a parking situation representative of the ground of the parking space 6. The data D thus provide information on whether, for example, a part of the parking space 6 is covered by the puddle 16 (see FIG. 2) or the ground of the parking space is asphalt 18 or lawn 20, for example (see FIG. 3).

Furthermore, in the present exemplary embodiment the data D, which are indicative of a parking situation, are personal data of the driver and/or passengers of the motor vehicle. The data D then indicate whether, for example, the driver and/or passenger of the motor vehicle 2 have individual restrictions on their mobility and therefore require a particularly large amount of space to leave the motor vehicle 2 which is parked in the parking space 6, as shown in FIG. 4. The personal data may be determined by an ID of the person, for example stored in an RFID tag, or by using values of weight sensors in vehicle seats, setting parameters of vehicle seats, seat belts, rear-view mirrors, pedals, and/or the steering wheel.

Finally, in the present exemplary embodiment the data D are indicative of a parking situation representative of a number of parking movements of a parking maneuver for parking in the parking space 6. The parking assistant 4 therefore determines the number of respective required parking movements in the in-vehicle operating mode SM and in the remote parking operating mode RM in order to park the vehicle 2 in the parking space 6. The operating mode with the smallest number of parking movements can be selected by the parking assistant 6 in the present exemplary embodiment.

In addition, reference is now made to FIG. 5 in order to explain a procedure for the operation of the parking assistant 4.

After activating the parking assistant 4 by pressing a button or falling below a certain speed, the vehicle's environmental sensors measure 2, for example transversely to the direction of travel, while passing one or more parking spaces 6. If the parking space 6 is large enough, this is indicated to the driver.

In a first step S100, the parking assistant 4 reads the data D indicative of a parking situation of the detected parking space 6.

In a further step S200, the parking assistant 4 evaluates the data D to determine the output signal AS indicative of the in-vehicle operating mode SM or the remote parking operating mode RM.

The data D indicative of a parking situation—as already stated—are geometry data of the parking space 6 and/or environmental data for an environment of the parking space 6 and/or representative of traffic situations in the vicinity of the parking space 6 and/or personal data of the driver and/or passengers of the motor vehicle 2 and/or representative of the ground of the parking space 6 and/or representative of a number of parking movements of a parking maneuver for parking in the parking space 6.

The parking assistant 4 provides an output signal AS indicative of the remote parking operating mode RM when the vehicle 2 is approaching a parking garage or is in a parking garage. For determination of the position, data of a navigation system of the motor vehicle 2 can be evaluated. Parking in a multi-floor car park can be challenging due to columns, poor lighting, and tight space for example. In such a scenario, the driver can leave the motor vehicle 2 without being exposed to adverse weather conditions, for example. For this purpose, meteorological data and/or state data can be indicative of an active windscreen wiper and/or readings for an outside temperature, for example. The meteorological data representative of the location of the motor vehicle 2 can be read in from a cloud. Traffic in such an environment is usually limited and slow or subject to restrictive speed limits. This allows the driver to take advantage of the remote parking.

The parking assistant 4 also provides an output signal AS indicative of the remote parking operating mode RM when the vehicle 2 approaches a home garage or a single garage. Again, for position determination the data of a navigation system of the motor vehicle 2 can be evaluated. In such home garages the space to disembark is often limited, so it is advantageous to use the remote parking operating mode RM.

The parking assistant 4 also provides an output signal AS indicative of the remote parking operating mode RM if the driver is, for example, obstructed or heavy, as this facilitates boarding and disembarking. The parking assistant 4 can take this into account and can select the remote parking operating mode RM for all parking spaces 6, regardless of the size and width of the parking spaces 6.

The parking assistant 4 also provides an output signal AS indicative of the remote parking operating mode RM if it has been determined that an optimal end position of the vehicle 2 is with a driver's door near an object, such as the motor vehicle 10, even if there is no limiting object on the passenger side. Alternatively, the parking assistant 4 may only offer parking spaces 4 which are limited by two objects of a certain type or size, such as the motor vehicles 8, 10.

Furthermore, the parking assistant 4 provides an output signal AS indicative of the remote parking operating mode RM if the ground on the driver's side or the entire area of the entire parking space 6 has undesirable properties. For example, the ground can be muddy, wet, icy, extremely hot, or otherwise unfavorable/unpleasant for a driver and/or passenger. In this case, the information about a ground state can be collected, for example, by camera images, meteorological data in combination with geodata or other suitable means of acquisition.

The parking assistant 4, on the other hand, provides an output signal AS indicative of the in-vehicle operating mode SM if there are parking time restrictions related to the detected parking space 6.

Furthermore, the parking assistant 4 determines whether the vehicle should park 4 forwards or backwards. For this purpose, the system determines which maneuver can be carried out faster, as well as with fewer parking movements, and then proposes the optimal parking maneuver.

Furthermore, the parking assistant 4 takes into account whether there is access to a particular motor vehicle 2, a tailgate or a door, whether certain parts such as the battery, wheels, and the like of the motor vehicle 2 are accessible for maintenance work.

Finally, the parking assistant 4 may be designed to weight the data D differently in determining the output signal AS, such as the number of required parking movements on the one hand and an orientation of the motor vehicle 2 in the parking space 6 on the other hand.

In a further step S300, the parking assistant 4 outputs the output signal AS optically and/or acoustically and/or haptically.

In a departure from this exemplary embodiment, the order of the steps may also be different. In addition, several steps can be performed at the same time or simultaneously. In addition, individual steps can also be omitted.

In this way, a driver can be given advice as to which operating mode of the operating modes is preferable in a current scenario. The system can also be designed to select the operating mode fully automatically.

### REFERENCE CHARACTER LIST

2 Motor vehicle
4 Parking steering assistant
6 Parking space
8 Motor vehicle
10 Motor vehicle
12 Motor vehicle
14 Motor vehicle
16 Puddle
18 Asphalt
20 Lawns
D Data
RM Remote parking operating mode
SM In-vehicle operating mode
S100 Step
S200 Step
S300 Step

1. A method for operating a motor vehicle (2) with a parking assistant (4) which can be operated in an in-vehicle operating mode (SM) and a remote parking operating mode (RM), with the steps:
(S100) reading data (D) indicative of a parking situation of a detected parking space (6),
(S200) evaluating the data (D) to determine an output signal (AS) indicative of the in-vehicle operating mode (SM) or the remote parking operating mode (RM), and
(S300) outputting the output signal (AS).

2. The method according to claim 1, wherein the data (D) are indicative of parking situation geometry data of the parking space (6).

3. The method according to claim 2, wherein the data (D) are indicative of parking situation environmental data for an environment of the parking space (6).

4. The method according to claim 3, wherein the data (D) are indicative of a parking situation representative of traffic situations in the vicinity of the parking space (6).

5. The method according to claim 1, wherein the data (D) are indicative of parking situation personal data of the driver and/or of passengers of the motor vehicle (2).

6. The method according to claim 1, wherein the data (D) are indicative of a parking situation representative of the ground of the parking space (6).

7. The method according to claim 1, wherein the data (D) are indicative of a parking situation representative of a number of parking movements of a parking maneuver and/or meteorological data and/or state data and/or measured values.

8. A computer program product designed to perform the method according to claim 1.

9. A parking assistant (4) for the operation of a motor vehicle (2), the parking assistant comprising:
an in-vehicle operating mode (SM) and a remote parking operating mode (RM), to read data (D) indicative of a parking situation of a detected parking space (6), to evaluate the data (D) to determine an output signal (AS) indicative of the in-vehicle operating mode (SM) or the remote parking operating mode (RM) and to output the output signal (AS).

10. The parking assistant (4) according to claim 9, wherein the data (D) are indicative of parking situation geometry data of the parking space (6).

11. The parking assistant (4) according to claim 9, wherein the data (D) are indicative of parking situation environmental data for an environment of the parking space (6).

12. The parking assistant (4) according to claim 9, wherein the data (D) are indicative of a parking situation representative of traffic situations in the vicinity of the parking space (6).

13. The parking assistant (4) according to claim 9, wherein the data (D) are indicative of parking situation personal data of the driver and/or of passengers of the motor vehicle (2).

14. The parking assistant (4) according to claim 9, wherein the data (D) are indicative of a parking situation representative of the ground of the parking space (6).

15. The parking assistant (4) according to claim 9, wherein the data (D) are indicative of a parking situation representative of a number of parking movements of a parking maneuver and/or meteorological data and/or state data and/or measured values.

16. A Motor vehicle (2) with a parking assistant (4) according to claim 9.
